(19) United States
(12) Patent Application Publication
(10) Pub. No.: US 2009/0204447 A1
(43) Pub. Date: Aug. 13, 2009

(54) METHOD AND SYSTEM FOR MITIGATING RISK IN ISSUING INSURANCE

(75) Inventors: Ricky G. Tucker, Woodstock, GA (US); Frank O. Moore, Clayton, NC (US); Laura Reinhard, Sparta, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/367,153

(22) Filed: Feb. 6, 2009

Related U.S. Application Data
(60) Provisional application No. 61/027,350, filed on Feb. 8, 2008.
(60) Provisional application No. 61/035,537, filed on Mar. 11, 2008.

(51) Int. Cl. G06Q 40/00

(52) U.S. Cl. 705/4

(57) ABSTRACT

A method for mitigating risk in issuing insurance comprising: submitting a request for the insurance; determining if a method, material, system or item complies with a predetermined set of parameters; and issuing the insurance, wherein the predetermined set of parameters is selected from the group consisting of: the installation of a foam insulation, ballistic resistance (e.g., adhesion products, Spectra products, and resins), cut resistance, energy management, alert sensors (e.g., smoke detectors, fire alarms and carbon monoxide detectors), process control, weather resistance, water resistance, mold resistance, loss of business, loss of property, loss to the environment, avionics, injury to persons, and security (e.g., document and personal security, money, anti counterfeiting).

### CROSS-REFERENCED APPLICATIONS

This application claims priority to U.S. Provisional Patent Application Nos. 61/027,350, filed on Feb. 8, 2008, and 61/035,537, filed on Mar. 11, 2008, both of which are incorporated herein in their entirety.

### BACKGROUND

1. Field

The present disclosure relates generally to a method and system for mitigating risk, such that underwriters will be able to issue insurance for otherwise high risk insurance situations. In particular, the mitigation of risk and issuance of insurance results from the insured complying with a predetermined set of parameters, such as insurance compliant methods, materials or systems, e.g., wind uplift foams or alert or alarm sensors on a residential or commercial structure.

2. Discussion of the Background Art

Availability and affordability of insurance remains a serious problem. Current insurance and risk mitigation methods and systems are not always integrated to mitigate loss and reduce premiums. The current methods and processes can be costly, with high deductibles, limited coverage, or coverage may not be available at all.

Current insurance and risk mitigation processes and methods are very arbitrary, focusing on probability of occurrence, with little attention to effectively mitigating or eliminating the risk events. An example is the cost and lack of property insurance that currently exists in the states of Florida and Louisiana after the past hurricane seasons. Other examples would be states having to bail out insurance companies and offer state-funded and state-backed insurance policies. In addition, it can sometimes be impossible to get insurance at any cost because of lack of insurance capacity for certain high risk assets.

The present disclosure provides many advantages to the insurance industry. It is cost effective, increases insurance availability, and increases insurance industry capacity.

The present disclosure also provides many additional advantages, which shall become apparent as described below.

### SUMMARY

A method for mitigating risk in issuing insurance comprising: submitting a request for the insurance; determining if a method, material or system complies with a predetermined set of parameters; and issuing the insurance. If the method, material, material or system is compliant, authorizing the request for the insurance. If the item does not comply with the predetermined set of parameters, arranging for a site visit. Analyzing at least a part of the method, material or system; optionally, selecting a material to correct the non-compliance; and installing the material.

The predetermined set of parameters are at least one selected from the group consisting of: the installation of a foam insulation, ballistic resistance, e.g., adhesion products, Spectra products, and resins, cut resistance, energy management, alert sensors, process control, weather resistance, water resistance, mold resistance, loss of business, loss of property, loss to the environment, avionics, injury to persons, and security.

Some additional areas for application of the risk mitigation system and process of the present disclosure include, but are not limited to: life safety insurance, moisture barrier insurance, airplane engine down time and predictive maintenance insurance, performance insurance for solar and other renewable energy installations, refinery and process plant uptime insurance, gas detection guarantees, fertilizer explosion insurance, commercial and residential break-in insurance, energy performance and pricing for multi-site retail insurance, and demand response performance guarantee insurance.

Preferably, the alert sensors are at least one selected from the group consisting of: smoke detectors, fire alarms and carbon monoxide detectors. Optionally, the security is at least one selected from the group consisting of: document and personal security, money security systems, and anticounterfeiting systems. Optionally, the compliant material comprises a foam insulation.

Preferably, the request is submitted via an Internet application or paper application. The method further comprises the step of prior to issuing the insurance, determining if all insurance standards are met.

Alternatively, the method, material, system or item is selected from the group consisting of: a pothole repair system, a camouflaged structure, and a vehicle protection system or combinations thereof.

According to another embodiment of the present disclosure, a method for issuing insurance comprises: providing an item, process or person to be insured; determining whether the item, process or person complies with a predetermined set of parameters; and issuing the insurance.

Another embodiment includes an integrated risk mitigation system comprising: a risk mitigation method, material or system; and insurance.

The risk mitigation method, material or system preferably complies with a set of parameters selected from the group consisting of: the installation of a foam insulation, ballistic resistance (e.g., adhesion products, Spectra products, and resins), cut resistance, energy management, alert sensors, process control, weather resistance, water resistance, mold resistance, loss of business, loss of property, loss to the environment, avionics, injury to persons, and security.

Preferably, the foam insulation comprising a rigid closed cell foam comprising: (a) a blowing agent, and (b) at least one compound selected from the group consisting of: a polyurethane, a polyisocyanurate, a phenol, a thermoplastic polymer and combinations thereof.

The alert sensors are at least one selected from the group consisting of: smoke detectors, fire alarms and carbon monoxide detectors. The security is at least one selected from the group consisting of: document and personal security, money security systems, and anticounterfeiting systems.

The risk mitigation method, material or system optionally comprises at least one selected from the group consisting of: a pothole repair system, a camouflaged structure, and a vehicle protection system or combinations thereof.

Still yet another embodiment of the present disclosure includes a risk mitigation insurance product comprising: a warranty against a harm to an item, process or person based on use of risk compliant method, material, system or item.

Further objects, features and advantages of the present disclosure will be understood by reference to the following drawings and detailed description.

### BRIEF DESCRIPTION OF THE DRAWINGS

FIG. 1 is a block diagram depicting the issuance of insurance according to the present disclosure;

FIG. 2 is a block diagram of a computer system adapted for employment of the method according to the present disclosure; and

FIG. 3 is a block diagram showing an Internet property quotation process according to an embodiment of the present disclosure.

### DETAILED DESCRIPTION OF THE PREFERRED EMBODIMENT

The present disclosure is applicable to building owners, insurers, reinsurers, brokers, contractors, suppliers, architects, engineers, lessees and any other person or entity that is subject to risk as a result of damage caused by failure to any risk mitigating method, material or system.

In one embodiment, applicable to insurers for example, the disclosure relates to a method or system for mitigating risk in issuing insurance comprising: receiving a request for the insurance; determining if an asset complies with a predetermined set of parameters; issuing the insurance; optionally reinsuring any risk, i.e., spreading the risk of insuring to a consortium of reinsurer such as a plurality of insurers. Still yet another approach to issuing of such wind insurance is through a select group of licensed insurance broker, wherein:
(1) one or more licensed insurance brokers would be appointed;
(2) the facilities or insurance program criteria would be established, including, but not limited to, (a) assign underwriting responsibilities to either an outside insurance company (e.g., AIG or ACE) or split underwriting responsibilities between outside insurance company(s) and a captive insurer (such as Alchem), and (b) establishment of minimal underwriting criteria that need to be met before insurance can be issued (such as physical site inspections);
(3) broker or insurer to issue insurance; and
(4) broker or insurer to collect insurance premium from insured, as well as to handle claims and state recordation requirements.

However, if a compliant method, material or system is already installed, the underwriter for the insurer can authorize the request for insurance. If the method, material or system does not comply with the predetermined set of parameters, then the insurer or the broker (as applicable) can arrange for a site visit. The method or system also includes analyzing the existing asset, optionally, selecting a material to correct the non-compliance; and installing a compliant method, material or system, e.g., installation of an uplift resistant material, such as a rigid closed cell spray foam, or an alert or alarm system.

The following shall be checked and verified regarding the compliant method, material or system prior to issuance of insurance. Determine that the compliant method, material or system meets all industry standards. The asset shall be inspected and in a warrantable condition by the manufacturer supplying the method, material or system.

Optionally, the set of parameters that need to be reviewed in order to issue insurance can include, but are not limited to, the installation of a foam insulation, ballistic resistance (e.g., adhesion products, Spectra products, and resins), cut resistance, energy management, alert sensors (e.g., smoke detectors, fire alarms and carbon monoxide detectors), process control, weather resistance, water resistance, mold resistance, loss of business, loss of property, loss to the environment, avionics, injury to persons, or security (e.g., document and personal security, money systems, and anticounterfeiting systems).

Optionally, the compliant material or item is selected from the group consisting of: a pothole repair system, a camouflaged structure, and a vehicle protection system or combinations thereof.

### Pothole Repair System

A system and method for repairing potholes which comprises: placing a securing mechanism within the existing pothole bottom or sidewalls, securing a reinforcing material to the securing mechanism to ensure its retention within the pothole, and filling or injecting a foam material to fill the pothole such that it encapsulates the securing mechanism and reinforcing material so that it is securingly retained within the potholes and substantially level to the surface of the roadway.

### Camouflaged Structure

A system and method for constructing a camouflaged structure or site by spraying polyurethane foam into a desired shape or configuration over the top of a camouflage material. The foam having sufficient adhesive properties to attach to the camouflage material, such as grass, leaves, rocks, sand, soil, wood chips, bark, building materials, garbage, debris, etc.

### Vehicle Protection System

A system and method for providing armoring to a vehicle by placing ballistic material inside the body panel assembly of the vehicle, such as a door panel, roof, trunk, seat bottom, etc., and spraying or injecting a polyurethane foam to adhere and stabilize the ballistic material therein are provided. Unexpectedly, the polyurethane foam also assists in the absorption of energy associated with projectile impact. The preferred ballistic materials are high tenacity, high modulus filament and polyethylene protective yams.

The preferred foam material is polyurethane and polyisocyanurate closed-cell foams prepared with a blowing agent comprising a hydrofluorocarbon selected from the group consisting of 1,1,1,3,3-pentafluoropropane, 1,1,1,2-tetrafluoroethane, 1,1,2,2-tetrafluoroethane, and mixtures thereof.

The present disclosure includes a unique foam, wherein the preferred foam is formed by a method of preparing polyurethane and polyisocyanurate foam compositions comprising the step of reacting and foaming a mixture of ingredients which react to form polyurethane or polyisocyanurate foams in the presence of a blowing agent comprising a hydrofluorocarbon selected from the group consisting of 1,1,1,3,3-pentafluoropropane, 1,1,1,2-tetrafluoroethane, 1,1,2,2-tetrafluoroethane, and mixtures thereof; and an effective amount of a blowing agent additive selected from the group consisting of: isobutanol, isopropanol and mixtures thereof; mixtures of α-methyl styrene and isobutanol; mixtures of α-methyl styrene and isopropanol; and mixtures of α-methyl styrene, isobutanol and isopropanol.

The additive is present in the amount of from about 0.02 to about 10 weight percent, based on the amount of blowing agent. Preferably, the additive includes α-methyl styrene. The α-methyl styrene is present in an amount of from about 0.02 to about 5 weight percent, based on the amount of blowing agent.

The blowing agent preferably comprises 1,1,1,3,3-pentafluoropropane and an effective amount of α-methyl styrene. The α-methyl styrene is present in the amount of from about 0.02 to about 5 weight percent, based on the amount of blowing agent. More preferably, the α-methyl styrene is present in the amount of from about 0.02 to about 2 weight percent, based on the amount of blowing agent.

Another embodiment includes a closed cell foam prepared from a polymer foam formulation containing a blowing agent comprising a hydrofluorocarbon selected from the group consisting of 1,1,1,3,3-pentafluoropropane, 1,1,1,2-tetrafluoroethane, 1,1,2,2-tetrafluoroethane, and mixtures thereof; and an effective amount of a blowing agent additive selected from the group consisting of: isobutanol, isopropanol and mixtures thereof, mixtures of α-methyl styrene and isobutanol; mixtures of α-methyl styrene and isopropanol; and mixtures of α-methyl styrene, isobutanol and isopropanol. The additive is present in the amount of from about 0.02 to about 10 weight percent, based on the amount of blowing agent. The additive includes α-methyl styrene. The α-methyl styrene is present in an amount from about 0.02 to about 5 weight percent, based on the amount of blowing agent.

The blowing agent preferably comprises 1,1,1,3,3 -pentafluoropropane and an effective amount of α-methyl styrene. The α-methyl styrene is present in the amount of from about 0.02 to about 5 weight percent, based on the amount of blowing agent. The α-methyl styrene is present in the amount of from about 0.02 to about 2 weight percent, based on the amount of blowing agent.

Optionally, the closed cell foam containing a cell gas comprising a blowing agent as defined above.

The additive is selected from the group consisting of isobutanol, isopropanol and mixtures thereof. The additive is present in the amount of from about 0.02 to about 10 weight percent, based on the amount of blowing agent.

Manufacturer Qualifications: Polyurethane foam and protective coating manufacturers shall show evidence of sufficient financial resources and manufacturing facilities to furnish materials on this project. References shall be required, sufficient project lists, warranties and code approvals shall be submitted for verification.

Inspections: The polyurethane foam and protective coating manufacturers are to provide qualified representatives to monitor and inspect the installation of their products. Manufacturers third party inspection of the installation is recommended. Manufacturers to provide published data sheets or letter of certification that their products comply with the materials specified. This is to include primers (if required), polyurethane foam and protective coatings.

Shop drawings on sheet metal, accessories, or other fabricated items.

Manufacturer's application or installation instructions.

Contractor/applicator certification from polyurethane foam supplier and/or protective coatings manufacturers and evidence of contractor/applicator qualification and experience.

A specimen copy of the applicable warranty for the project.

Approval and information guides for applicable local, or national codes and/or insurance acceptability, if required.

Safety and handling instructions for storage, handling and use of the materials to include appropriate Materials Safety Data Sheets (MSDS).

Field Quality Control Procedures to be utilized by the contractor/applicator to insure proper preparation and installation of polyurethane foam and protective coatings, detail work and follow-up inspection.

In another embodiment applicable to the owner or lessee for example, the present disclosure relates to a method for mitigating risk comprising: submitting a request for insurance; submitting an application for insurance; optionally, enabling a site visit to enable a determination of whether the currently installed compliant method, material or system meets a predetermined set of parameters; optionally, facilitating the installation of a compliant method, material or system; receipt of insurance; and, optionally, paying an insurance premium. If damage occurs to the insured asset due to failure of the compliant method, material or system, then the process or system would also include a mechanism for filing of a claim and issuance of a claim payment.

In still another embodiment applicable to contractors, for example, the present disclosure relates to a method for mitigating risk comprising: submitting a proposal for installation of compliant method, material or system which meets a predetermined set of parameters; optionally, determining if an existing method, material or system complies with a predetermined set of parameters; optionally, enabling a site visit to enable a determination of whether the compliant method, material or system meets a predetermined set of parameters; optionally, installing a compliant method, material or system; submitting an application for insurance; receipt of insurance; and, optionally, paying an insurance premium. If a failure occurs due to such compliant method, material or system, then the process or system would also include the filing of a claim and issuance of a claim payment.

Each of the steps of receiving, advertising, distributing, soliciting, determining, authorizing, issuing, scheduling and reinsuring can each be accomplished by any means known in the art, including, but not limited to: electronic means (e.g., Internet, facsimile, or any other known electronic transfer system), mail, courier, personal deliver (i.e., in person), etc.

The predetermined set of parameters comprises the installation of a compliant method, material or system which meets a predetermined set of parameters. The set of parameters that need to be reviewed in order to issue insurance can include, but are not limited to, the installation of a foam insulation, ballistic resistance (e.g., adhesion products, Spectra products, and resins), cut resistance, energy management, alert sensors (e.g., smoke detectors, fire alarms and carbon monoxide detectors), process control, weather resistance, water resistance, mold resistance, loss of business, loss of property, loss to the environment, avionics, injury to persons, or security (e.g., document and personal security, money, anticounterfeiting).

Optionally, the compliant method, material, system or item is selected from the group consisting of: a pothole repair system, a camouflaged structure, and a vehicle protection system or combinations thereof.

Another preferred compliant material is the use of a wind uplift foam on a roof or other building structure, such a foam comprises a layer of a rigid closed cell foam, and wherein the building system comprises: (a) a rigid closed cell foam (e.g., a rigid closed cell spray foam); and (b) a concrete deck or wall, wherein the layer of a rigid closed cell foam is affixed to the deck or wall, preferably by spray application.

The rigid closed cell foam (also referred to as a rigid closed cell spray foam) comprises (a) a blowing agent, and (b) at least one compound selected from the group consisting of: a polyurethane and/or a polyisocyanurate polymer or combinations thereof. It is well know to those of skill in the art that foams described as polyisocyanurate foams are typically a mixture of polyisocyanurate and polyurethane polymers.

Any blowing agent and other additives known to be useful in polyurethane and/or polyisocyanurate polymers may be used in the present disclosure. ENOVATE® 245fa blowing agent is the preferred blowing agent.

Furthermore, the present disclosure relates to the automatic purchase of insurance for assets with compliant methods, materials or systems.

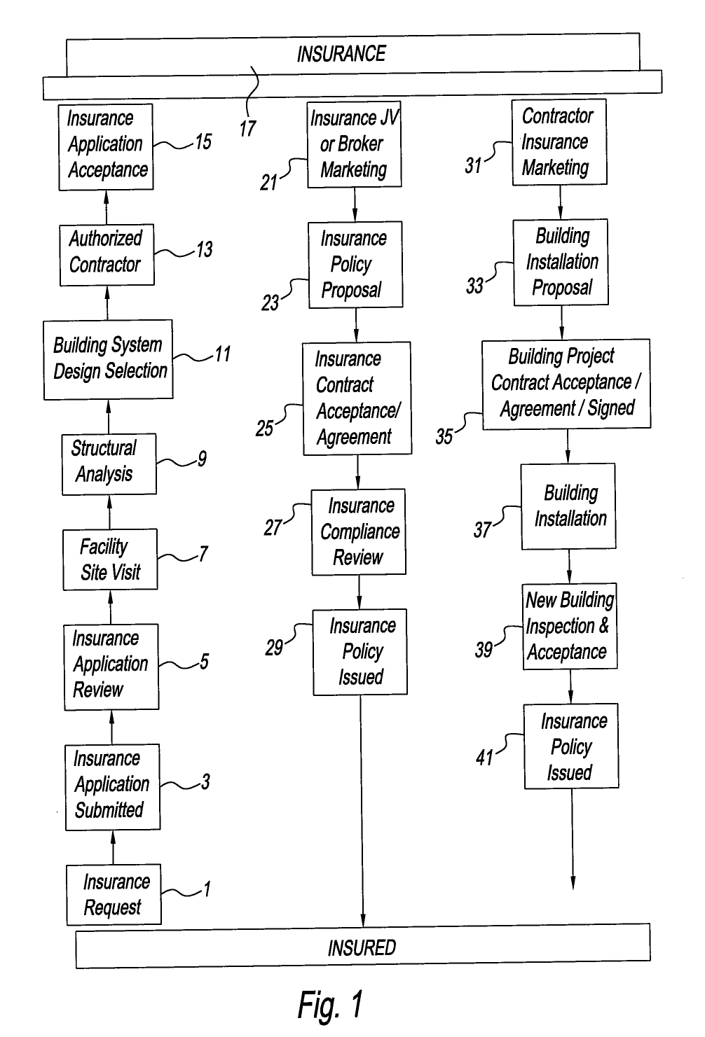

The present disclosure can best be explained by reference to FIG. 1 which depicts three instances where risk may be mitigated and insurance issued to cover a building, e.g., the buildings roof. The first embodiment of the present disclosure involves requesting insurance 1, followed by the submission of an insurance application 3. After the application 3 has been submitted, an underwriter reviews the insurance application 5 and, optionally, conducts a facility site visit 7. If a facility site visit 7 is performed, then a structural analysis of the current building is undertaken 9 by an inspector. If the inspection determines that the currently installed roofing system does not meet a predetermined set of parameters, then the building owner has the option of selecting a fully compliant roofing system 11. Once the compliant roofing system is selected, then a roofing contractor can be hired to install the compliant roofing system 13. Once the compliant roofing system has been installed, then the insurance application can be accepted 15 and insurance can be issued 17.

In another embodiment of the present disclosure, an insurance joint venture or insurance broker can market wind roof insurance 21 to building owners by sending an insurance policy proposal 23. Thereafter, an insurance contract is sent to the building owner 25 for execution. Upon receipt of the executed insurance contract, then an insurance compliant review is initiated 27 to determine if the roofing system includes a compliant material which meets or exceeds a predetermined set of parameters. If so, then an insurance policy is issued. 29.

Still another embodiment described in FIG. 1, relates to a method whereby a contractor markets an insurance product together with his roofing contract 31. That is, the contractor submits a roof installation proposal to a building owner 33. If the owner accepts the proposal, then a formal contract for services and insurance is sent to the owner for execution 35. Once the contract is executed by both parties, the contractor installs the roof 37. Thereafter, the underwriter of the insurance undertakes an inspection of the roof 39 to ensure that the roof system includes a compliant material that meets or exceeds a predetermined set of parameters. If the compliant material meets or exceeds a predetermined set of parameters, then the insurer issues an insurance policy to the building owner 41.

To avoid redundancy of tasks, all of the method steps of each embodiment discussed throughout this application can be conducted by one or more individuals, groups, or computers.

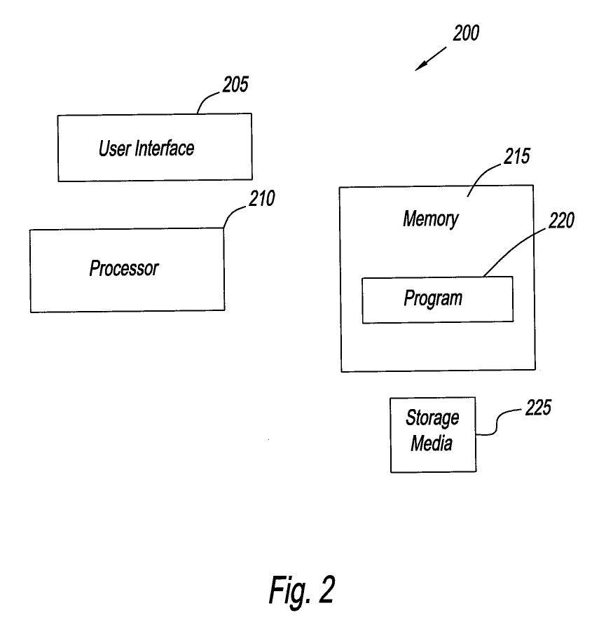

FIG. 2 is a block diagram of a computer system 200 adapted for employment of the present invention. System 200 includes a user interface 205, a processor 210, and a memory 215. System 200 may be implemented on a general purpose microcomputer. Although system 200 is represented herein as a standalone system, it is not limited to such, but instead can be implemented as a distributed computer system via a network (not shown).

Memory 215 is a memory for storing data and instructions for controlling the operation of processor 210. An implementation of memory 215 would include a random access memory (RAM), a hard drive and a read only memory (ROM). One of the components of memory 215 is a program 220.

Program 220 includes instructions for controlling processor 210 to execute the steps described above in association with the method of FIG. 1. Program 220 may be implemented as a single module or as a plurality of modules that operate in cooperation with one another. The term “module” is used herein to denote a functional operation that may be embodied either as a stand-alone component or as an integrated configuration of a plurality of sub-ordinate components.

User interface 205 includes an input device, such as a keyboard or speech recognition subsystem, for enabling a user to communicate information and command selections to processor 210. User interface 205 also includes an output device, such as a display or a printer. A cursor control such as a mouse, track-ball, or joy stick, allows the user to manipulate a cursor on the display for communicating additional information and command selections to processor 210.

While program 220 is indicated as a component of memory 215, it may be configured on a storage media 225 for subsequent loading into memory 215. Storage media 225 can be any conventional storage media such as a magnetic tape, an optical storage media, a compact disk, or a floppy disk. Alternatively, storage media 225 can be a random access memory, or other type of electronic storage, located on a remote storage system (not shown) and coupled to memory 215.

### Rigid Closed Cell Foam

Closed cell spray polyurethane and polyisocyanurate foams, including their formulation and application in housing insulation applications are well known in the art. In general, polyurethane or polyisocyanurate foams are prepared by combining an (1) isocyanate, (2) a polyol, (3) a blowing agent, and optionally (4)—other additives. Each of these components and their processing to make polyurethane and polyisocyanurate foam formulations for building insulation applications is described below.

### Isocyanate Component

Any organic polyisocyanate can be employed in polyurethane or polyisocyanurate foam synthesis inclusive of aliphatic and aromatic polyisocyanates. Preferred as a class, are the aromatic polyisocyanates. Preferred aromatic polyisocyanates for rigid polyurethane or polyisocyanurate foam synthesis include the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2.

These polyisocyanates can be used alone or in any combination. Suitable commercially available isocyanates include: Lupinate® M20S from BASF, PAPI 27 from Dow, Rubinate® M from Huntsman, and Mondur® MR from Bayer.

The amount of isocyanate in polyurethane or polyisocyanurate foam formulations is generally in the range of about 40 to about 60 weight percent of the total foam formulation.

### Polyol Component

Typical polyols used in the manufacture of rigid polyurethane or isocyanurate foams include, but are not limited to, (i) aromatic amino-based polyether polyols such as those based on mixtures of 2,4- and 2,6-toluenediamine condensed with ethylene oxide and/or propylene oxide, (ii) aromatic alkylamino-based polyether polyols such as those based on ethoxylated and/or propoxylated aminoethylated nonylphenol derivatives, (iii) sucrose or sorbitol-based polyols such as those based on sucrose derivatives and/or mixtures of sucrose and glycerine derivatives condensed with ethylene oxide and/or propylene oxide, (iv) polyols derived from natural products including without limitation soy and flaxseed oil, (v) aromatic polyester polyols such as those based on complex mixtures of phthalate-type or terephthalate-type esters formed from polyols such as ethylene glycol, diethylene glycol, or propylene glycol. These polyols may used alone or in any combination.

Suitable commercially available polyols include: Voranol® 470X from Dow, Jeffol® A630 from Huntsman, Terate® 4020 from Kosa, Voranol® 370 from Dow.

The amount of polyol in the polyurethane or polyisocyanurate foam formulations is generally in the range of about 20 to about 40 weight percent of the total foam formulation.

### Blowing Agent Component

The blowing agent component can be any blowing agent known to be useful in the manufacture of polyurethane or polyisocyanurate foam. Generally these materials include: fluorocarbons (including chlorofluorocarbons (CFCs), hydrochlorofluorocarbons (HCFCs), hydrofluorocarbons (HFCs), hydrocarbons (HCs), water, CO₂, fluoroesters, fluoroethers, fluoroketones, fluoroolefins (HFOs), organic acids, ethers, esters, alcohols, and trans-1,2-dichloroethylene.

Preferred physical blowing agents are those that have some or all of the following are non-flammable, liquid, have a low molecular weight, no or low (<about 0.01 ozone depletion potential (ODP) and have a low global warming potential (GWP) (that is a GWP of less than about 1500, more preferably about 1000 or less, still more preferably less than about 500, and most preferably less than about 150):

Suitable physical blowing agents include but are not limited to:

HCFCs and HFCs of from about 1-4 carbon atoms, and HCs of from about 4-6 carbon atoms.

In certain embodiments, pentafluoropropenes are preferred, including particularly those pentafluoropropenes in which there is a hydrogen substituent on the terminal unsaturated carbon, such as CF₃CF═CFH (HFO-1225yez), particularly since applicants have discovered that such compounds have a relatively low degree of toxicity in comparison to at least the compound CF₃CH═CF₂ (HFO-1225zc).

The term “HFO-1234” is used herein to refer to all tetrafluoropropenes. Among the tetrafluoropropenes are included 1,1,1,2-tetrafluoropropene (HFO-1234yf) and both cis- and trans-1,1,1,3-tetrafluoropropene (HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The term “HFO-1233” is used herein to refer to all trifluoro monochloropropenes. Among the trifluoromonochloropropenes are included 1,1,1,trifluoro-2,chloro-propene (HFO-1233xf) and both cis- and trans-1,1,1-trifluo-3,chlororopropene (HFO-1233zd). The term HFO-1233zd is used herein generically to refer to 1,1,1-trifluo-3, chloro-propene, independent of whether it is the cis- or trans-form. The terms “cisHFO-1233zd” and “transHFO-1233zd” are used herein to describe the cis- and trans-forms of 1,1,1-trifluo,3-chlororopropene, respectively. The term “HFO-1233zd” therefore includes within its scope cisHFO-1233zd, transHFO-1233zd, and all combinations and mixtures of these.

The term “HFO-1225” is used herein to refer to all pentafluoropropenes. Among such molecules are included 1,1,1,2,3 pentafluoropropene (HFO-1225yez), both cis- and trans-forms thereof. The term HFO-1225yez is thus used herein generically to refer to 1,1,1,2,3 pentafluoropropene, independent of whether it is the cis- or trans-form. The term “HFO-1225yez” therefore includes within its scope cisHFO-1225yez, transHFO-1225yez, and all combinations and mixtures of these.

HFOs derived from 365mfc including without limitation HFO-1354 and HFO-1345 may also be used as blowing agents in this application.

Preferred physical blowing agents include but are not limited to: 1,1-dichloro-1-fluoroethane (HCFC-141b); 1,1,1,2-tetrafluoroethane (HFC-134a); 1,1,1,2-tetrafluoroethane (HFC-134); 1-chloro-1,1-difluoroethane; 1,1,1,3,3-pentafluorobutane(HFC-142b); 1,1,1,2,3,3,3-heptafluoropropane (HFC-227ea); difluoroethane; 1,1,1,3,3-pentafluoropropane (HFC-245fa), 1,1,1,2-tetrafluoroprop-1-ene (HFO-1234yf), 1,2,3,3,3-pentafluoroprop-1-ene (HFO-1225ye), 1-chloro-3,3,3-trifluoroprop-1-ene (HFO-1233zd), 1,1,1,3-tetrafluoroprop-1-ene (HFO-1234ze), 1,1,1,4,4,4-hexafluorobut-2-ene (HFO-1336mzzm(e) and HFO-1336mzzm(z)), and combinations of any of the foregoing or combinations of any of the foregoing with other suitable blowing agents.

Suitable commercially available physical blowing agents include ENOVATE® 245fa from Honeywell and SOLKANE® 365mfc available from Solvay. When used alone these materials are present in an amount of about 3 to about 15 weight percent of the total foam formulation. When 245fa and 365mfc are used in combination they may be used in any combination however physical blowing agent compositions which are 245fa rich (i.e., >50 weight percent of the physical blowing agent composition is composed of HFC-245fa).

Chemical blowing agents include but are not limited to compounds that react with the isocyanate to liberate a gas. Preferred chemical blowing agents include water and organic acids like formic acid.

Generally speaking, the amount of blowing agent present in the foam formulation is dictated by the desired foam densities of the final polyurethane or polyisocyanurate foams products. The polyurethane and polyisocyanurate foams produced can vary in density from about 1.0 to about 6.0 pounds per cubic foot, more preferably from about 1.5 to about 4.0 pounds per cubic foot and most preferably 1.8 to 4 pound per cubic foot. The density obtained is a function of how much of the blowing agent, or blowing agent mixture, is present in the A and/or B components, or that is added at the time the foam is prepared.

The amount of physical blowing in the polyurethane or polyisocyanurate foam formulations is generally in the range of about 3 to about 15 weight percent of the total foam formulation while the amount of chemical blowing agent in such formulations is generally in the range of about 0 to about 3 weight percent of the total foam formulation.

### Catalysts:

Any catalyst useful in the manufacture of polyurethane and/or polyisocyanurate foam may be used in the invention. Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

The amount of amine catalyst in the polyurethane foam formulation is generally in the range of about >0 to about 5 weight percent of the total foam formulation.

Optionally, non-amine polyurethane catalysts may be used in the polyurethane foam formulation. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

The amount of non-amine catalyst in the polyurethane foam formulations is generally in the range of about >0 to about less than 1 weight percent of the total foam formulation.

In the preparation of polyisocyanurate foams, trimerization catalysts are used for the purpose of converting excess (i.e., greater than the amount required to react with the polyol and other isocyanate-reactive components in the foam formulation). Any trimerization catalyst known to be useful in the manufacture of polyisocyanurate foam may be employed in the present invention. These catalysts include, but are not limited to, glycine salts and tertiary amine trimerization catalysts, alkali metal carboxylic acid salts, and mixtures thereof. Preferred species within these classes are potassium acetate, potassium octoate, and N-(2-hydroxy-5-nonylphenol)methyl-N-methylglycinate.

The amount of trimerization catalyst in the polyisocyanurate foam formulation is generally in the range of about >0 to about less than 5 weight percent of the total foam formulation.

### Other Additives:

There are numerous additives that may be added to the foam formulation to optimize properties of the formulation. They include without limitation: surfactants, cell stabilizers, flame retardants, viscosity modifiers, crosslinking agents, solubolizers, dispersing agents, colorants, adhesion promoters, vapor pressure suppressants and stabilizers. These are all well known in the art. Generally additives are present in the foam formulation in an amount of >0 to about 15 weight percent of the total foam formulation

Closed-cell spray foam suitable for this application preferably have the following nominal properties:

| Property | ASTM Test | Unit | Value |
|---|---|---|---|
| Nominal Density: | D-1622 | lbs/ft³ | 1.5-4.0 |
| Sprayed-in-Place | | | |
| R Value at 75° F. | C-518 | R/inch | 5.0-8.0 |
| mean temperature, | | | |
| measured 6 months | | | |
| after foam | | | |
| manufacture | | | |
| Compressive | D-1621 | Psi | 20-60 |
| Strength: Parallel to | | | |
| Rise | | | |
| Tensile Strength | D-1623 | Psi | 30-100 |
| Closed Cell Content | D-2856 | % | >80 |

Useful closed-cell spray foams are disclosed in U.S. Pat. Nos. 6,414,046; 7,214,294; 6,843,934, 6,806,247, 6,790,820; 6,784,150, among others which are incorporated herein by reference.

Useful closed-cell spray foams include Comfort Foam® FE178, FE158, CF178, CF158 commercially available from BASF Polyurethanes—Foam Enterprises (a division of BASF) of Florham Park, N.J.; BaySeal™ 2.0 commercially available from BaySystems (a division of Bayer) of Spring, Tex.; Corbond® commercially available from Corbond of Bozeman, Mont.; HeatLok Soy 0240 commercially available from Demilec USA of Arlington, Tex.; Styrofoam™ 2.0 commercially available from Dow Chemical Company of Midland, Mich.; PF-173, PF-193 commercially available from Gaco Western of Seattle, Wash.; Permax commercially available from Resin Technology Division (a division of Henry Co.) of Ontario, Calif.; Foam Lok™ FL-2000™ commercially available from Lapolla Coatings of Houston, Tex.; InsulStar® commercially available from NCFI Polyurethanes (formerly North Carolina Foam Industries) of Mt. Airy, N.C.; and DuraFoam—Duraseal™ 1.9 commercially available from Urethane Contractor Supply Company of Phoenix, Ariz.

### Preparation and Application of the Rigid Closed Cell Foam

The preparation of polyurethane and polyisocyanurate foam is well known in the art. It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component. The polyol or polyol mixture, surfactant, catalyst(s), blowing agent(s), flame retardant, and other isocyanate reactive components comprise the second component, commonly referred to as the “B” component. While the surfactant, catalyst(s) and blowing agent are usually placed in the “B” component, they also may be added to the “A” side, or added to both the “A” and “B” sides.

When spray foam is applied, the A-side chemicals (e.g. polyisocyanate) and B-side chemicals are mixed in appropriate amounts, typically equal amounts by volume, and then atomized into a mist. This mixing is done in a spray gun. The polyurethane or polyisocyanurate foam is created as the two chemicals mix and are deposited on the building surface. Optionally, fire retardant, colorants, auxiliary blowing agents, water, and even other polyols can be added as a third stream to the mix head of the spray gun.

Substrate preparation shall include removing loose dirt, dust and debris by using compressed air, vacuum equipment or brooming. Oil, grease, form release agents or other contaminants shall be removed with proper cleaning solutions. All joint openings in concrete decks that exceed ¼ inch shall be grouted or caulked prior to application of polyurethane foam. Priming is required on concrete surfaces, and it is recommended that poured concrete decks be permitted to cure for twenty-eight (28) days prior to the application of primer or sprayed polyurethane foam.

Sprayed polyurethane foam is not recommended for lightweight or insulating concrete unless tests have been made to determine that adequate adhesion can be obtained or unless an overpayment is installed. Prior to application of the foam, the surface shall be inspected to insure that conditions have been met.

Substrate shall have sufficient slope to eliminate excessive ponding water. Ponding is defined as the excessive accumulation of water at low-lying areas on a roof that remains 48 hours after the end of rainfall under conditions conducive to drying. If the substrate does not have sufficient slope, then the ponding water must be eliminated by building in slope by the application of polyurethane foam, channeling the polyurethane foam or by the proper placement of drains, or a combination thereof.

The polyurethane foam application shall not proceed during periods of inclement weather. The applicator shall not apply the polyurethane foam below the temperature and/or humidity specified by the manufacturer for ambient air and substrate. Wind barriers may be used if wind conditions could affect the quality of installation.

The spray polyurethane foam shall be applied in accordance with the manufacture's specification and instructions.

Areas to be built-up to remove ponding water are to be filled in with spray polyurethane foam before the specified thickness of polyurethane foam is applied to the entire building surface. The spray polyurethane foam must be applied in a minimal pass thickness of ½ inch. Spray polyurethane foam thickness shall be a minimum of one inch (or more if specified). The polyurethane foam shall be applied uniformly over the entire surface with a tolerance of plus ¼″ per inch of thickness minus 0″, except where variations are required to insure proper drainage or to complete a feathered edge. The spray polyurethane foam shall be uniformly terminated a minimum of four (4) inches above the roofline at all penetrations (except drains, parapet walls, or building junctions). Foamed in place cants shall be smooth and uniform to allow positive drainage.

The polyurethane foam surface shall be allowed to cure sufficiently. The full thickness of polyurethane foam in any area shall be completed prior to the end of each day. If due to weather conditions more than 24 hours elapse between polyurethane foam and coating application, the polyurethane foam shall be inspected for UV degradation, oxidation or contamination. If any of the above conditions exist, the surface shall be prepared in conformity with the recommendations of the manufacturer issuing the warranty.

The final sprayed polyurethane foam surface shall be “smooth, orange peel, coarse orange peel, or verge of popcorn.” Polyurethane foam surfaces termed “popcorn” or “treebark” are not acceptable. These areas shall be removed and refoamed to an acceptable surface.

Any damage or defects to the polyurethane foam surface shall be repaired prior to the protective coating application.

Polyurethane foam surface shall be free of moisture, frost, dust, debris, oils, tars, grease or other materials that will impair adhesion of the protective coating.

Prior to the application of the protective coating the polyurethane foam shall be inspected for suitability of base coat application. The polyurethane foam shall be clean, dry, and sound.

The base coat shall be applied the same day as the polyurethane foam application when possible. In no case shall less than two hours elapse between application of the polyurethane foam and application of the base coat. If more than 24 hours elapse prior to the application of base coat, the polyurethane foam shall be inspected for UV degradation.

The polyurethane foam shall be free of dust, dirt, contaminants and moisture before application of the base coat. The base coat shall be applied at a uniform thickness with the rate of application being governed by the polyurethane foam surface texture. Coatings shall be applied at such a rate as to give the minimum dry film thickness specified by the protective coating manufacturer. The coating shall be allowed to cure and be inspected for pinholes, thinly coated areas, uncured areas or other defects. Any defects should be repaired prior to subsequent applications. The base coat shall be free of dirt, dust, water, or other contaminants before application of the topcoat. The coating application shall not proceed during periods of inclement weather. The applicator shall not apply the protective coating below the temperature and/or above the humidity specified by the manufacturer for ambient air and substrate. Wind barriers may be used if wind conditions could affect the quality of installation.

Subsequent coating should be applied in a timely manner to insure proper adhesion between coats. Surface texture of polyurethane foam will affect dry film thickness—additional material may be required in areas of coarse foam profile.

The cured dry film thickness of the finished multiple coat application shall be checked by taking slit samples and examining under magnification. Areas that are found to have less than the thickness specified shall require additional coating.

According to one embodiment, the present disclosure provides a method of securing a building structure against wind forces tending to lift the deck or walls thereof which comprises:

a) providing a deck or wall;

b) spraying and adhering a rigid closed cell foam onto at least a portion of the deck or wall. The foam may be applied to the top or underside of the roof deck. Typically, the foam is applied to the top of the deck or outer surface of the wall in a commercial installation and the underside of the deck or wall in a residential installation; and

(c) optionally coating said foam with a UV resistant material. Foam UV resistant material would include, but are not limited to silicone, polyurea, acrylic, urethane, asphalt coatings, membrane roof waterproofing sheets, pavers, aggregate, or poured in-place concrete protection surfacing.

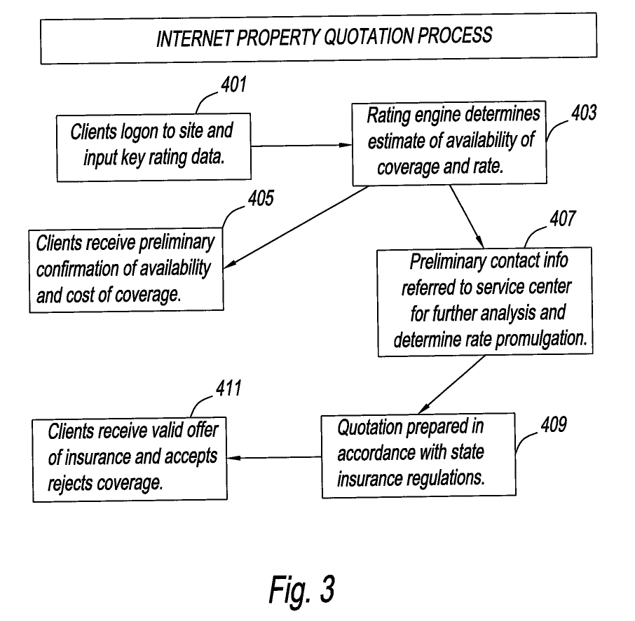

FIG. 3 demonstrates an Internet property quotation process according to an embodiment of the present disclosure, wherein clients logon to a website and input key rating data 401. Thereafter, a rating engine determines the estimate of availability of coverage and rate 403. Clients then receive preliminary confirmation of availability and cost of coverage 405 or are referred to a service center for further analysis and determination of rate promulgation 407. A quotation is then prepared in accordance with state insurance regulations 409 and client receives a valid offer of insurance and accepts or rejects coverage 411.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims. For example, it is contemplated that all presently known and available methods and systems for forming foam are readily adaptable for use in connection with the present disclosure.

What is claimed is:

1. A method for mitigating risk in issuing insurance comprising:
submitting a request for said insurance;
determining if a method, material or system complies with a predetermined set of parameters; and
issuing said insurance.

2. The method according to claim 1, further comprising:
if said method, material or system is compliant, authorizing said request for said insurance.

3. The method according to claim 1, further comprising:
if said item does not comply with said predetermined set of parameters, arranging for a site visit.

4. The method according to claim 3, further comprising:
analyzing at least a part of said method, material or system;
optionally, selecting a material to correct the non-compliance; and
installing said material.

5. The method according to claim 1, wherein said predetermined set of parameters is selected from the group consisting of: the installation of a foam insulation, ballistic resistance, cut resistance, energy management, alert sensors, process control, weather resistance, water resistance, mold resistance, loss of business, loss of property, loss to the environment, avionics, injury to persons, and security.

6. The method according to claim 5, wherein said alert sensors are at least one selected from the group consisting of: smoke detectors, fire alarms and carbon monoxide detectors.

7. The method according to claim 5, wherein said security is at least one selected from the group consisting of: document and personal security, money security systems, and anticounterfeiting systems.

8. The method according to claim 4, wherein said compliant material comprises a foam insulation.

9. The method according to claim 1, wherein said request is submitted via an Internet application or paper application.

10. The method according to claim 1, further comprising:
prior to issuing said insurance, determining if all insurance standards are met.

11. The method according to claim 1, wherein said item is selected from the group consisting of: a pothole repair system, a camouflaged structure, and a vehicle protection system or combinations thereof.

12. The method according to claim 11, wherein said compliant material is a polyurethane or polyisocyanurate closed-cell form prepared using a blowing agent comprising a hydrofluorocarbon selected from the group consisting of: 1,1,1,3,3-pentafluoropropane, 1,1,1,2-tetrafluoroethane, and mixtures thereof.

13. A method for issuing insurance comprising:
providing an item, process or person to be insured;
determining whether said item, process or person complies with a predetermined set of parameters; and
issuing said insurance.

14. An integrated risk mitigation system comprising:
a risk mitigation method, material or system; and insurance.

15. The system of claim 14, wherein said risk mitigation method, material or system is complies with a set of parameters selected from the group consisting of: the installation of a foam insulation, ballistic resistance, cut resistance, energy management, alert sensors, process control, weather resistance, water resistance, mold resistance, loss of business, loss of property, loss to the environment, avionics, injury to persons, and security.

16. The system of claim 15, wherein said foam insulation comprising a rigid closed cell foam comprises (a) a blowing agent, and (b) at least one compound selected from the group consisting of: a polyurethane, a polyisocyanurate, a phenol, a thermoplastic polymer and combinations thereof.

17. The method according to claim 15, wherein said alert sensors are at least one selected from the group consisting of: smoke detectors, fire alarms and carbon monoxide detectors.

18. The method according to claim 15, wherein said security is at least one selected from the group consisting of: document and personal security, money security systems, and anticounterfeiting systems.

19. The system of claim 14, wherein said risk mitigation method, material or system comprises at least one selected from the group consisting of: a pothole repair system, a camouflaged structure, and a vehicle protection system or combinations thereof.

20. A risk mitigation insurance product comprising:
a warranty against a harm to an item, process or person based on use of risk compliant method, material, system or item.
